(19) United States
(12) Patent Application Publication
(10) Pub. No.: US 2004/0093277 A1
(43) Pub. Date: May 13, 2004

(54) Method and system for secure electronic purchase transactions

(76) Inventors: Erik Stener Faerch, Helsinge (DK); Paul Justus Wear JR., Los Angeles, CA (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/460,734

(22) Filed: Jun. 12, 2003

(30) Foreign Application Priority Data
Jun. 12, 2002 (DK) PA 2002 00893

(51) Int. Cl. G06F 17/60

(52) U.S. Cl. 705/26

(57) ABSTRACT

The present invention relates to systems and methods for implementing secure purchases over a computer network. More particularly, the methods relate to a system which permits purchases of merchandise to be made over a computer network, whereby the purchaser may feel confident that personal credit card information is not at risk of being diverted, misappropriated or stolen and the vendor may be more confident that the purchaser is bona fide before shipment of goods.

The present invention relates to a method and a system for secure transactions on a public computer network, in particular for sales/payment on the World Wide Web.

### BACKGROUND

The present invention relates to systems and methods for implementing secure purchases over a computer network. More particularly, the methods relate to a system which permits purchases of merchandise to be made over a computer network, whereby the purchaser may feel confident that personal credit card information is not at risk of being diverted, misappropriated or stolen and the vendor may be more confident that the purchaser is bona fide.

It is well known for users of merchandise to access the global client/server network commonly referred to as the Internet, a part of which is the World Wide Web, for the purpose of searching for and purchasing merchandise from on-line vendors selling wares ranging from travel services and investment services to CD recordings, books, software, computer hardware and the like.

The method of paying for services and product on the World Wide Web using an account on a supplier's web site is well known, and several different systems to accomplish this exist. Systems for communicating are, among others, SSL protocol.

These known techniques all require that account information (cardholder's name, card number, expiry date, company names) has to be transmitted every time a purchase is made on the World Wide Web.

The known techniques that require account information to be sent, include a well known risk that somebody may misuse this information. It only requires knowledge of the account information to misuse it in the current techniques.

Numerous patents teach methods or systems purporting to secure commercial credit card transactions carried out over the Internet. Examples of such patents include the following.

U.S. Pat. No. 6,360,254 discloses a system and a method for providing secure URL-based access to private resources so that users may be allowed to securely access a private resource without the need to enter a username, password, or other authentication information, and without the need to download special authentication software or data to the user's computer. Each resource is assigned a private uniform resource locator (URL) which includes a fixed character string and a unique token, and the URLs are conveyed by e-mail (preferably using hyperlinks) to users that are entitled to access such resources. The method may be used to provide users secure to access private account information on the Web site of merchant. The method may also be used to enable a user to securely perform a particular type of transaction, such as confirm an order, redeem an electronic gift certificate or coupon, or cast a vote. The reference does not describe a system for arranging payment directly with a confidential payment system.

U.S. Pat. No. 6,330,550 describes a system for payment and sales transactions on the Internet. A user desiring to buy a product or service from a seller identifies himself with an identification code to the seller. The seller provides the code to a payment system, and the payment system requests confirmation from the user before payment is released. The identification code is stored at least temporarily on the seller's server.

WO 01/78023 describes a system for order and payment request confirmation in electronic commerce. A unique customer code along with a list of goods is transmitted to a merchant s website. The merchant sends the code and the total goods value to an agent system which sends a request comprising a special password to the customer. On receiving the password from the customer, the agent sends an order of money transfer to a bank. The bank sends money to the merchant's account and confirms the payment together with customer delivery address. The seller's website forwards information from the user, whereby the seller's website at least temporarily stores the information from the user.

WO 01/55979 describes a payment device to perform secure payment via the Internet without sending credit card details by requesting a secure confirmation from the client for effecting the payment. A client database, a service provider database, a transaction database, a verification database and a certification database are connected to payment service equipment. A client chooses and pays for services/goods on a site, places the order, fills in a form using the mobile phone number as a confirmation and sends it to the service provider, sending it to the PS, encrypted if required. The identification of the client is checked as well as validity of the payment card, before payment information is sent to the bank.

The seller's website stores information from the user, at least temporarily.

WO 95/16971 describes a method for purchasing of goods or information over a computer network. Merchant computers on the network maintain databases of digital advertisements that are accessed by buyer computers. In response to user inquiries, buyer computers retrieve and display advertisements from merchant computers. The buyer computers allow the users to purchase the product described by an advertisement. The form of payment can be requested after a purchase is initiated. A payment system performs payment authorization. The payment system obtains account authorizations from an external financial system. Payment orders are signed with authenticators.

U.S. Pat. No. 5,826,241 describes a payment system for enabling a first Internet user to make a payment to a second Internet user, typically for the purchase of an information product deliverable over the Internet. The payment system provides cardholder accounts for the first and second Internet users. When the second user sends the information product to the first user over the Internet, the second user also makes a request over the Internet to a front end portion of the payment system requesting payment from the first user. The front end portion of the payment system queries the first user over the Internet whether to proceed with payment to the second user. If the first user replies affirmatively, a charge to the first user is processed off the Internet; however, if the first user replies negatively, the first user is not charged for the information product. The payment system informs the second user regarding whether the first user's decision and pays the second user upon collection of the charge from the first user. Security, is maintained by isolating financial and credit information of users' cardholder accounts from the front end portion of the payment system and by isolating the account identifying information from the associated e-mail address. In the system described it is the seller's website that directs payment information to the payment system.

U.S. Pat. No. 6,029,150 describes a method of payment in an electronic payment system wherein a plurality of customers have accounts with an agent. A customer obtains an authenticated quote from a specific merchant, the quote including a specification of goods and a payment amount for those goods. The customer sends to the agent a single communication including a request for payment of the payment amount to the specific merchant and a unique identification of the customer. The agent issues to the customer an authenticated payment advice based only on the single communication and secret shared between the customer and the agent and status information which the agent knows about the merchant and/or the customer. The customer forwards a portion of the payment advice to the specific merchant. The specific merchant provides the goods to the customer in response to receiving the portion of the payment advice. The system described comprises the feature of directing payment request directly from the user to the confidential payment system and thereby also confirms with the user, but does not describe a situation wherein the confidential payment system corresponds with the seller's website. Furthermore, no description of the security of the confidential payment system is described.

Most of the disclosed systems have the disadvantage that they rely on the transmission of sensitive information over unsecured network routes and lines for each transaction. Although practically speaking, the systems which rely solely on encryption are fairly safe, there is still some risk of credit card misappropriation and there is little psychological comfort given to potential users by their knowing that encryption is being used.

Furthermore, most of the systems that provide secured network routes require that a separate program be downloaded for the user to get access to the system.

### SUMMARY OF THE INVENTION

According to surveys and other marketing data, there always has been and there still exists a high percentage of the population which is deterred from purchasing merchandise directly over the Internet. This large percentage of the population apparently fears that, despite all the efforts at security and cryptography promised by the vendors, there still exists the possibility that their credit account information will be intercepted on-line by a third party computer hacker and used illegally, at great expense and trouble for the cardholder.

Thus, it is an objective of the present invention to provide a system and a method for potential on-line purchasers of merchandise marketed over a public network to pay for those purchases with minimized exposure to the risk of credit card theft by electronic interception.

It is a further objective of the invention to provide a mechanism for facilitating e-commerce which will increase the confidence of the consuming public in the safety of such transactions

An additional anxiety-inducing factor related to merchandising over a public network, or e-commerce, is that the vendor cannot always be certain that just because he has obtained credit card or account information, that he will actually be paid for the merchandise he ships. After all, credit card fraud and/or theft occur regularly and may not be caught in time to stop the order from being shipped. When the cardholder discovers the theft and stops the card, it may be too late for the vendor to recover his property. At the very least, this situation leads to unnecessary aggravation and wasted resources for the vendor, credit card company and cardholder. Accordingly, it is a further objective of the invention to provide a mechanism for facilitating e-commerce which will increase the confidence with which vendors may ship the purchased product or deliver the purchased service without fear of the payment being provided fraudulently.

Accordingly, this invention concerns a method to exchange payments for goods and service via a public network, utilizing credit cards or bank accounts (hereinafter both will be referred to as “account”), however without sending account numbers between payer (user) and seller. This is accomplished by a method for enabling a secure electronic purchase transaction on a public computer network, said network comprising

a secure agent computer system having stored thereon account information for a plurality of users,

a user computer,

a seller's website, said seller's website having a link to the secure agent computer system,

said method comprising

sending from said user computer a purchase request to the seller's website, said user computer also activating the link on said seller's website, thereby forwarding the purchase data to the secure agent computer system,

said secure agent computer system sending an acknowledgement request to the user,

upon acknowledgement from said user, said secure agent computer system forward notification to the seller's website and initiates payment to the seller, and

said seller executing the purchase request.

As described in the following, a safer method of transferring payments between two or more parties operating on for example the World Wide Web is created by means of the present invention, since the invention in detail:

1. Eliminates the need for users to send account information with every transaction.

2. Eliminates the possibility for hackers to obtain account information by hacking the supplier's/seller's website.

3. Ensures that account information is not generally accessible by minimizing the number of instances said information needs to be sent to one instance in the lifetime of each card, thus minimizing the number of websites storing information about the customer's account.

4. Eliminates that hackers may come across account information stored in the user's “Field-Auto completion-Database” which is part of the windows registry and often sadly easy to decode.

Thereby it becomes possible to reduce the number of instances where criminals have the opportunity to misuse account information for personal gain, yet enabling customers to purchase goods and services from any website connected to this invention.

Furthermore, the present invention offers the advantage that no special programming of the user computer is necessary for the user to perform secure payments on the network.

The term “link” is used in its normal meaning, i.e. a link to another website or computer, whereby a user activating the link is directed to another website or computer, in the present situation a website or computer of the secure agent computer system.

The term “website” or “web page” is also used in its normal meaning, i.e. an Internet server location assigned a URL (Uniform Resource Locator) address. The purchaser selects his merchandise and the vendor usually requests payment by one of several methods, one of which usually includes payment by providing credit card information.

In another aspect the invention relates to a system for enabling a secure electronic purchase transaction on a public computer network, said network comprising

a secure agent computer system having stored thereon account information for

a plurality of users,

a user computer,

a seller's website, said seller's website having a link to the secure agent computer system.

The system is suitable for implementing the method according to the invention.

### DRAWINGS

FIG. 1 demonstrates the steps users will need to take to initiate a purchase on a supplier's website using the method according to the invention. No personal information is exchanged.

FIG. 2 demonstrates how the secure agent system matches purchase and personal information through an encryption system.

FIG. 3 describes how URLs for user to follow are generated, as well as where scripts will be found.

FIG. 4 describes the process of user acknowledgement

FIG. 5 describes a profile structure according to the invention.

FIG. 6 shows a chart of the process of purchase using the method according to the invention.

FIG. 7 shows a chart of the process of payment according to the invention.

### DETAILED DESCRIPTION OF THE INVENTION

### Network

As is discussed hereinabove, the present invention is designed to reduce compromising the security of one's credit account information which can be caused by transmitting the information over an unsecured network, such as the World Wide Web. However, the invention may also be applied in other networks, such as other e-mail-based systems having a plurality of users.

As a layer of security, all traffic on the World Wide Web into or out of user browsers may be done in a protected form, such as by SSL (Secure Socket Layer) communication.

### User

The user may be any user, such as private persons or companies desiring to purchase on a public network, the only requirement for the user being that he or she has established at least one piece of account information with a secure agent computer system. In the present context the user is also called the purchaser.

Since the invention works using standard software, such as an Internet browser and e-mail software, the purchase may be performed from any computer connected to the network.

### Seller

The seller according to the invention offers wares for sale on the network. In the present context, the term seller is used synonymously with the term vendor. The seller's wares may range from travel services and investment services to CD recordings, books, software, computer hardware and the like.

The wares are offered for sale through a seller's website. In order for the seller to be part of the system, the seller's website has a link to the secure agent computer system, so that identification information from the user may be directed directly to the secure agent computer system when the user activates the link, without any identification information being stored on the seller's server. Thus, the only requirement for the seller is that he presents the link on his website, whereby a purchase from the website may be conducted safely using the secure agent computer system. A seller signs up to the system automatically through the secure agent computer system or manually through the secure agent system.

The link presents itself as an added button on the seller's website, and tells the user to click on it if payment by the secured system of the invention is desired. By clicking the button, the user initiates a series of events which will be described further herein below.

### Secure Agent/Back Server

The secure agent is a third party in relation to the user and the seller. The secure agent stores-account information from the user, corresponds with the user in relation to each purchase on the network, and authorises payment to the seller after acknowledgement by the user. In order to provide the necessary security, the part of the secure agent storing the account information and other personal information is never visible on the network.

In a preferred embodiment, the secure agent computer system comprises a first computer and a second computer, wherein said account information is maintained at said second computer, said second computer not being accessible from the public computer network. In a more preferred embodiment, the secure agent computer system further comprises a web/script server. In the present context, the term “first computer” is synonymous with Front Server, and the term “second computer” is synonymous with Back Server.

The account information is preferably maintained at the second computer, said second computer not being accessible from the public computer network.

The user desiring to perform safe payments through the method and system according to the invention signs up with the secure agent. The user must then inform the secure agent computer system of accounts that are going to be used for payment as well as other personal information, such as name, address, telephone, fax and/or e-mail address. To increase the security even more, the account and personal information may even be split into two parts, for example on two different server systems, one part containing user name, address, phone, and a second part containing credit card information; or half of the name, address, etc. numbers on one system, and the other half on the other system. This would ensure that if anyone gains illegal access to one system, it would only contain useless encrypted information.

The account information may be transmitted to the secure agent computer system by any suitable means, such as conventional mail, e-mail or entered through a secure website. Once the account information is forwarded to the secure agent computer system, there is no requirement for account information to be transmitted again, and in particular no requirement that account information is transmitted during purchase, thus reducing the risk of anyone unintentionally gaining access by unlawfully creating mirror websites, hacking supplier websites and gaining account access or by other-means scanning traffic to websites with security holes.

Accordingly, this present method establishes a single point of entering account information, and limits the number of times an account holder has to enter his information to 1 (one) time in the lifetime of each account.

Payment from user to Web supplier can be handled by several different means. The user can choose to transfer money from his/her bank account or a credit card. In the present context, the terms “Web supplier” and “Web seller” and “seller” are used synonymously. Accordingly, the account information may be any type of account information of which it is possible to conduct payment, such as bank account information or credit card information.

Once the secure agent computer system has received the account information it issues a unique a profile or user name to the user, this unique profile or user name also being denoted user identification code. The profile or user name can be of own choice or can be system generated. Furthermore, the user receives a password that can be of own choice or system generated. The identification code preferably does not contain any part of the account number, nor does it contain any other sensitive information about the user or his means of payment. It is only a reference identifier used to connect a purchase item/transfer funds between a payer recipient and the secure agent system.

The secure agent computer system is preferably built around a set of profiles and subprofile.

Each user has a unique master profile. This profile contains relevant user information, such as the user's name, address, phone, etc.

Appended to each master profile, the user can create any number of subprofiles. Each of these profiles relates to an account.

The user is preferably allowed to give these subprofiles logical names, such as “Private” or “Clinic” or “business 05”. This will make it easy to separate accounts that may be used for business or private purchases.

A more complex profile structure will be created for companies that may have a large number of accounts.

The subprofile structure can be defined in groups adding special rights to each group and define things like purchase approver and standard place of shipment.

The subprofiles can also relate to account within the company itself, so that purchases made will generate bills and receipts with the correct company account numbers included, thus making bookkeeping simpler.

Thus, the profile structure allows different people to use the same hardware. One account may have multiple users, with multiple shipping addresses or billing addresses.

After having received the profile or user name as well as the password, the user may use the method and system according to the invention.

When the user activates the link on the seller's website, the user is directed to the secure agent computer system, wherein the user may enter the identification code and password to the secure agent computer system. The comparison of the user identification code and password may be conducted in any suitable part of the secure agent computer system, it is however preferred that the second computer comprises means for matching user identification code and password with account information.

Thus, the secure agent Back Server stores all personal information in the system, and it is never visible on the World Wide Web. The secure agent Back Server is because of this preferably placed behind several different firewalls, through which it only communicates with the systems it is designed for. Communication from the first computer to the second computer is preferably encrypted. Since communication is preferably being done only through encryption, it will be necessary for other systems that need to communicate with it to be on a predefined list of recipients that at intervals will receive a “public” encryption key. But even receiving a key will not be enough to communicate. Whatever is sent will also be checked for correct sender of the received encryption format. This can be done by ensuring that there are several encryption formats available—though each one unique to the specific sender system.

In a further preferred embodiment, the communication between the first computer and the second computer is preferably a one-way communication from the first computer to the second computer. Thus, it is preferred that incoming communication enters the secure agent computer system through the first computer, is encrypted and forwarded to the second computer. In this embodiment, the second computer does not receive any communication apart from the first computer. The second computer may, on the other hand, transmit outgoing communication, such as communication to a script server, or communication to a financial institution, such as a bank or a credit institution, or communication to the user.

In one embodiment, as a security option only one-way communication may occur between the front server, the back server and the web/script server.

In addition to the two servers described above, the secure agent computer system may further comprise a separate web/script server, for generating a script for the user to either acknowledge or annul.

In a preferred embodiment the secure agent system comprises a fourth server (communication server) that may be the only one that communicates with account suppliers, i.e. the financial institutions. Such communication is also further protected by secure communication methods. This server can decrypt the account numbers for the transmission purposes to the account suppliers. The fourth server only communicates in with the second server, and has no other connections to the system.

### Initiating a Purchase

Every time the user desires to purchase goods or information from a seller on the network, he may do so securely, if the seller presents a link to the secure agent computer system on the seller's website thereby signalling that they use the secure agent system.

The user may browse around the seller's website for identifying the goods or information etc. to purchase. After having decided what to purchase, the user may initiate a payment by activating the link on the seller's website.

In one embodiment of the invention,.the user is prompted for an identification code and a password when activating the link on said seller's website. The link directs the user to the secure agent computer system wherein the user enters his identification code and password on the secure agent computer system, preferably to the first computer. When the user is directed to the secure computer system, user interaction with the seller's website has ended. Information about the purchase may be transferred to the secure agent system in several ways.

The user may enter the purchase information to the secure agent computer system after having identified himself through identification code and password. The seller's server may transfer purchase information to the secure agent computer system.

Purchase data normally includes information about the purchase, such as seller's identification, items, amount and in particular price and total sum. In a preferred embodiment the purchase data only includes seller's transaction identification and the total amount to be paid.

The secure agent computer system, after having received the user's purchase data, preferably generates an on-screen message to the user. For example, in one embodiment the secure agent web server returns an on-screen message, saying that the next step will be handled by the secure agent system, and that an acknowledgement e-mail is pending.

Thereafter the user may end the network transaction, or in a more preferred embodiment the user is redirected to the seller's website, after having received the message, and thereafter the user may finalise.

### Seller Interaction with Secure Agent System

One of the advantages of the present invention is that no identification code or password is exhibited to the seller or the seller's server and no personal information is stored on the seller's server. The only correspondence between the seller and the secure agent system is communication relating to purchase information as well as payment communication. After having received purchase information the secure agent computer system may generate and forward to the seller's server an electronic receipt with a control code to indicate that the information which reached the secure agent system is in its correct form. The code may be sent to a predefined IP address or URL of the seller's server.

### Processing Information at the Secure Agent Back Server and Secure Agent Web/Script Server

Furthermore, after having received purchase information the secure agent computer system initiates processing of the information.

In the following the process is described in relation to a secure agent computer system having at least a first computer and a second computer:

Encryption: The secure agent Front Server receives identification code and password and encrypts the data. The encrypted data is then sent to the secure agent Back Server.

Communication from the front server will be done by key encryption. But even receiving a key will not be enough to communicate. Whatever is sent may also be checked for correct sender of the received encryption format.

Comparison: The secure agent Back Server decrypts the information and pairs it with the user's personal and account information stored on the Back Server.

Once all of these conditions are met, the secure agent will commence processing the received information. In case the comparison step is negative, then a message may be presented informing that no user can be identified.

During the processing of the secure payment order, the secure agent system requests acknowledgement from the user, communicates with a financial institution, and communicates with the seller.

In one embodiment wherein the secure agent system comprises a script server, the secure agent generates a URL that combined with an e-mail address is sent to the secure agent Web/Script Server (could also be a separate mail server). The secure agent generates an e-mail on the basis of this information. This email is then sent to the user. Accordingly, in one embodiment the acknowledgement step comprises that the secure agent computer system generates an e-mail to the user. In a preferred embodiment, it is the secure agent web/script server that generates the e-mail.

In another aspect of the present invention, the system is configured such that the request for a confirmation of a purchase transaction is forwarded in the form of an SMS (short message system) note to a user's cellular communications device, such as a cellular phone, alphanumeric pager or modem-equipped handheld computer. Thus, if the user was not sitting at the system registered computer, he can still be advised instantly that someone else, perhaps illegally, is attempting to fraudulently use his account.

Simultaneously herewith, the secure agent may generate subprofile scripts for all accounts that the current user has registered with the secure agent system. These scripts are then passed on to the secure agent web/script server.

The secure agent web/script server may in turn generate a web page with a URL matching the one sent to the user. Each of the scripts representing account subprofiles will present themselves as clickable links on the page, each clickable link preferably being an individual URL.

The URL of the generated web page may be a URL forwarded to the user when the user signed on to the secure agent system, or in a more preferred embodiment the URL is generated de novo for each purchase, thereby increasing the security of the system. The URL may be forwarded to the user by any suitable means. In a preferred embodiment the URL of the generated web page is forwarded to the user with the e-mail forwarded for acknowledgement.

In a preferred embodiment, it is the second computer that generates the URL and communicates with the web/script server and generates the subprofiles.

### Acknowledgement

The acknowledgement step secures that the user, i.e. the individual originally signing up to the secure agent system, is informed that the user's identification code and password has been used to purchase wares from a seller's website, since acknowledgement information is forwarded to the communication address belonging to the user, said address originally being transferred to the secure agent system together with account data when signing up to the system. Thereby, the user may detect any fraud of his or her identification code before any payment has been conducted.

In the case that the user accepts the purchase, he must acknowledge the purchase request, which is performed by entering the site of the URL generated by the secure agent system, and thereby clicking the URL representing the subprofile of the desired account for payment.

Annulment of the purchase request may be done in at least two different ways: Either by not clicking any URL representing a subprofile of an account, or by clicking an annulment clickable link.

The web page generated is preferably deleted after the user's acknowledgement or annulment of the purchase request. To increase security, the generated web page hosting the subprofiles generated is preferably deleted after a predetermined time period. Thereby, not having acknowledged within a predetermined period of time is considered annulment of the purchase request. This may be accomplished for example by storing time information (such a creation or expiration time/date) in a look-up table.

The annulment/acknowledgement information received on the generated web page is preferably transferred to the second computer for processing. In one embodiment, the web/script server directly forwards the acknowledgement/annulment information to the second computer. In a more preferred embodiment, in particular in a one-way system, the web/script server forwards acknowledgement/annulment information to the first computer, and said first computer forwards the acknowledgement/annulment information to the second computer.

In a preferred embodiment, the secure agent computer system, after having received acknowledgement from the user, forwards information to the user, said information for example including purchase data and/or information about the selected account.

### User's Final Approval

In one embodiment, upon receiving the e-mail requesting approval, the user has two choices.

1. Clicking the URL of the desired subprofile. This will initiate payment using the appended account.

2. Not clicking any URL will by the end of the scripts TTL annul the order, and the supplier's web server will be informed of this annulment.

In another embodiment, the user has the following choices:

1. Clicking the URL of the desired subprofile. This will initiate payment using the appended account.

2. Clicking the URL of an annulment, thereby annulling the purchase request.

Clicking the URL of the subprofile by which the user wants, to pay—thus by which account—returns a command to the secure agent web/script server what profile was selected. There may be an additional request for confirmation in case of several profiles, to offer the user the opportunity to change to the desired profile—depending on number of profiles.

Each time a purchase is made, the user may receive an e-mail message requiring confirmation before the account issuer is notified and a charge to the account is made. This additional level of security ensures that the user knows each and every charge made to the account. No transmission of sensitive account information is made at this time between the user and the confirming server.

Once the secure agent system receives confirmation of the purchase request, transaction of funds is initiated. The funds will be drawn from the appropriate subprofile and its appended account.

If it is a credit card subprofile, the verification process may be initiated by standard technology.

If it is a bank account subprofile, a transfer of funds may be initiated.

### Communication with Account Supplier

Once acknowledgement from the user has been received in the secure agent computer system, the secure agent computer system communicates with an account supplier for the selected account.

In order to provide high security for the seller, it is preferred that the seller does not ship any wares to the user, before the seller has been assured that it is the right user who has ordered the wares, and that the seller's payment is assured. Accordingly, in one embodiment the secure agent computer system initiates verification with an account supplier before notifying the seller of acknowledgement of the purchase request. In another embodiment, the secure agent computer system receives payment from the account supplier before notifying the seller of acknowledgement of the purchase request.

The payment from the account supplier may be conducted in any suitable way. Payment may be transferred directly from the account supplier to the seller's account, whereby the secure agent system merely directs payment. Payment may also be transferred from the account supplier to the secure agent system, and further on to the seller's account.

The secure agent computer system communicates with the account supplier, independent of the type of account supplier. It is preferred that it is the second computer that communicates with the account supplier in order to increase the security, optionally by using the communication server as described above.

The notification of the seller may be conducted from any suitable part of the secure agent computer system; it is, however, preferred that the first computer notifies the seller in order to increase security of the system.

Finally, an e-mail may be sent to the user containing all information regarding the transactions related to the current purchase. Another message may be sent to the supplier stating an approval of payment, and an ETA of said payment.

This ends the involvement of the secure agent system in the user's purchase. The only remaining step is shipping of wares from the seller to the user.

In the following, the invention will be explained in detail in relation to the drawings.

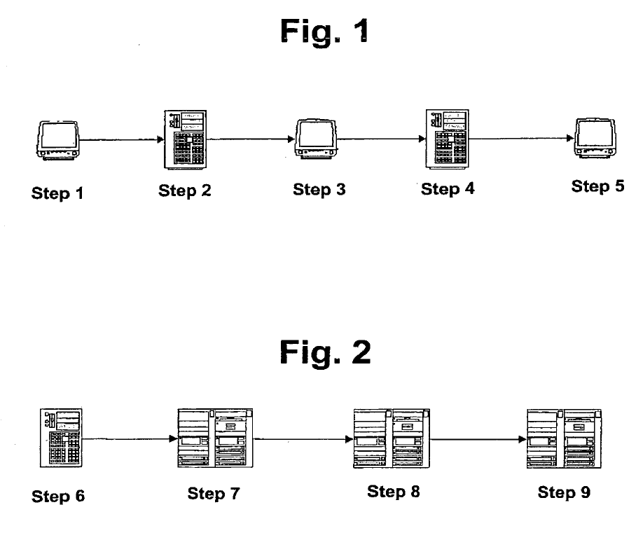

FIG. 1 shows the necessary steps for the user to perform to initiate a secure payment from a vendor's website. In step 1, the user initiates the purchase by clicking on the secure agent link on the vendor's web page. In step 2, the user is directed to the secure agent first computer after which, in step 3, he signs on with the identification code and password. In step 4, an e-mail is sent from the secure agent script server containing the URL of the temporary page. Finally, in step 5, the user responds to the URL, chooses a payment profile, authorization is secured, and the vendor is notified for fulfillment.

In FIG. 2, the processing in the secure agent computer system is shown graphically. Thus, in step 6, the supplier's web server sends purchase data to the secure agent server. The secure agent server receives purchase data in step 7 and presents the sign-on screen. In step 8, the secure agent first computer encrypts the information and passes it to the secure agent second computer, and in step 9 the secure agent second computer matches encrypted information with user identification code and password, verifying the presence of account information.

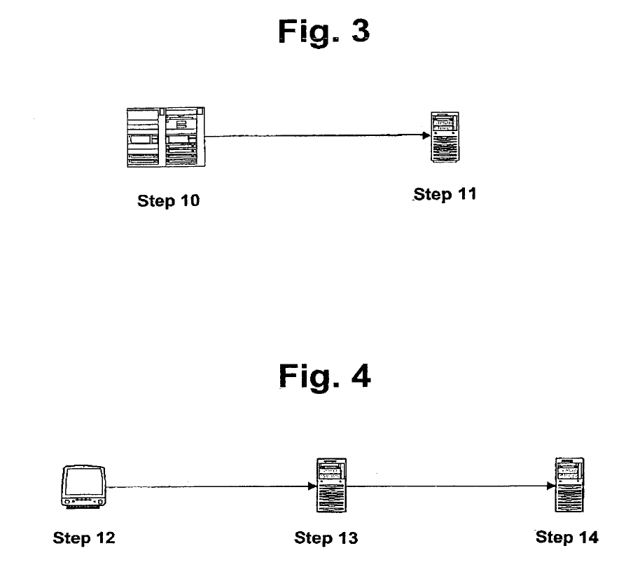

In FIG. 3, the process of generating URLs for users to follow is shown. In step 10, the secure agent second computer generates subprofile information and sends it to the secure agent script server. In step 11, the secure agent script server generates a temporary page and awaits user access. The scripts have a time-to-live limit.

In FIG. 4, the process of user acknowledgement is shown. In step 12, the user receives confirmation request e-mail, and confirms by clicking the URL, which thus sends him to the script server. The secure agent script server receives the user's URL request in step 13 and returns a web page asking the user to click on an account profile name. In step 14, the script server returns script activation to second computer with relevant subprofile and deletes payment scripts.

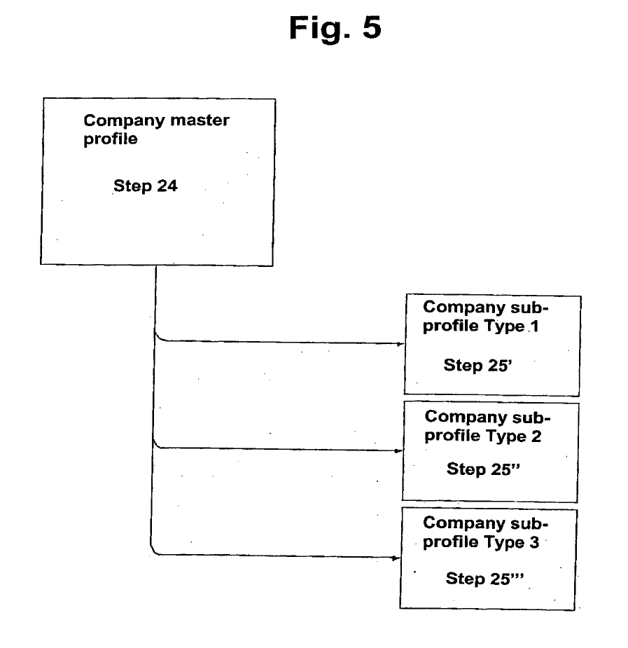

FIG. 5 shows a simplified company profile structure where three subprofiles and their rights have been defined. From this point, it is easy to grant or deny an employee rights within the profile, by simply adding or removing him from the profiles list of members.

Thus, in FIG. 5, step 24, the company master profile contains company information, such as address, phone, e-mail, etc. as well as the responsible contact person and company profile administrators. The profile could contain one or more company credit cards including information about responsible approver. It also contains the billing address for all subprofiles. In step 25′, the company subprofile type 1 contains employees permitted to either use credit cards in the company master profile or their own company credit cards. Approval mail recipient(s) is/are added here. In step 25″, the company subprofile type 2 contains employees permitted to use credit cards in the company master profile. Approval mail recipient(s) is/are added here. In step 25′″, the company subprofile type 3 contains employees permitted to use their own company credit cards. Approval mail recipient(s) is/are added here.

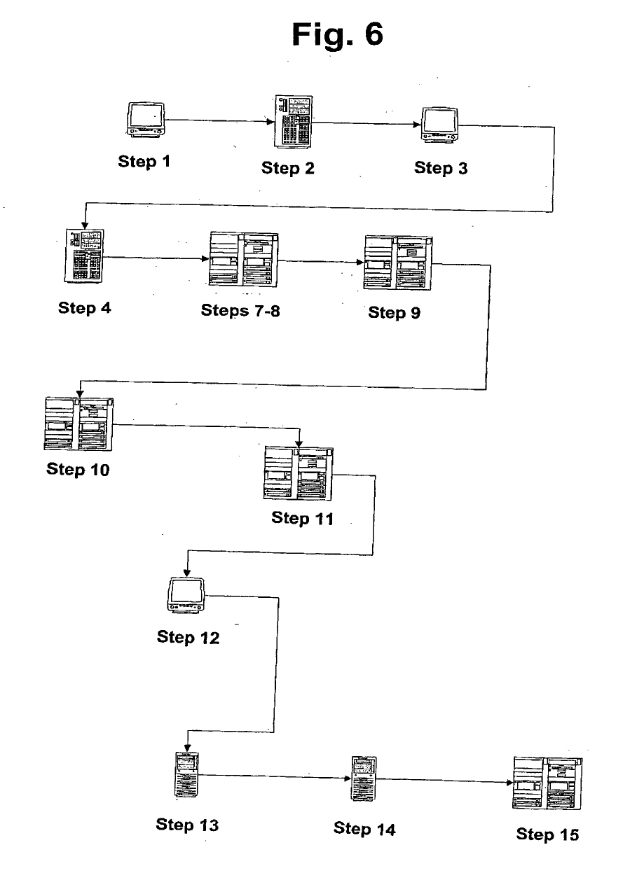

In FIG. 6, the whole purchase process is shown wherein in step 1 the user initiates the purchase on the vendor's web site by clicking on the secure agent payment option. In step 2, the supplier's web server requests secure agent identification code and password, and in step 3 the user enters secure agent identification code and password to the secure agent computer system. In step 4, the vendor's web server sends purchase data to the secure agent server at the same time as the identification request. The secure agent web server receives the purchase request in steps 7-8, encrypts the information, and passes it to the secure agent second computer. In step 9, the secure agent second computer verifies the encrypted information with identification code, password, and account data, and in step 10 the secure agent second computer sends subprofile data to the script server. In step 11, the secure agent script server receives subprofile data and generates an e-mail and a temporary web page. In step 12, the user receives a purchase confirmation request e-mail and confirms by clicking on the URL, thus sending him to the script server. In step 13, the user chooses a subprofile on the temporary page on the script server and receives a message stating that the order will be processed. A receipt is sent to the user by e-mail. In step 14, the script server returns processing data to the back server for payment and deletes relevant scripts. The back server receives confirmation in step 15 and initiates an account transaction with the card processor.

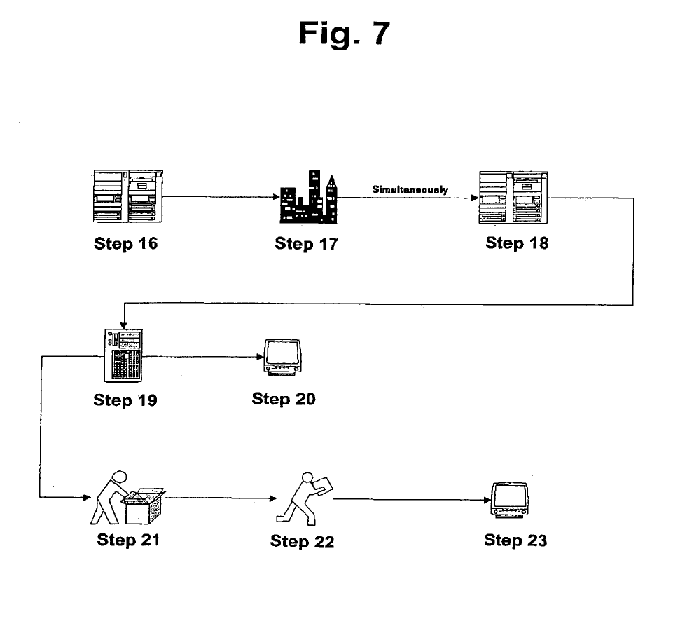

In FIG. 7, the steps after acknowledgement are shown. In step 16, the secure agent back server initiates the transaction through the communication server with the financial institution. The financial institution approves the card in step 17 and sends payment to the secure agent communication server which a) logs the payment on the back server, and b) notifies the script server to send a receipt to the user. In step 18, the secure agent communication server transfers funds to the vendor's account. In step 19, the web/script server generates a confirmation e-mail to the user that the purchase transaction is completed, and generates an e-mail to the seller that payment has been conducted. The user receives a confirmation mail in step 20, the vendor packs (step 21) and ships (step 22) the order, and the user receives the orders in step 23.

In the embodiments discussed above, the secure agent comprises a first computer (front server), a second computer (back server) and a web/script server. It is, however, also contemplated by the present invention that the secure agent system may comprise other computers/servers, for example for dividing information onto more servers. Furthermore, it is also possible to use fewer computers/servers so that the processes discussed above to take place on individual servers may be performed on one or two servers as long as the security is maintained.

1. A method for enabling a secure electronic purchase transaction on a public computer network, said network comprising
a secure agent computer system having stored thereon account information for a plurality of users,
a user computer,
a seller's website, said seller's website having a link to the secure agent computer system,
said method comprising
sending from said user computer a purchase request to the seller's website, said user computer also activating the link on said seller's website, thereby forwarding the purchase data to the secure agent computer system,
said secure agent computer system sending an acknowledgement request to the user,
upon acknowledgement from said user, said secure agent computer system forward notification to the seller's website and initiates payment to the seller, and
said seller executing the purchase request.

2. The method according to claim 1, wherein the public computer network is the Internet.

3. The method according to claim 1 or claim 2, wherein the user enters the identification code and/or password to the secure agent computer system after having activated the link.

4. The method according to any of the preceding claims, wherein the secure agent computer system comprises a first computer and a second computer, wherein said account information is maintained at said second computer, said second computer not being accessible from the public computer network.

5. The method according to claim 3, wherein the second computer comprises means for matching user identification code and password with account information.

6. The method according to any (if the preceding claims, wherein the secure agent computer system further comprises a web/script server.

7. The method according to any of the preceding claims, wherein the acknowledgement step comprises that the secure agent computer system generates an e-mail to the user.

8. The method according any of the preceding claims, wherein the acknowledgement step comprises that the secure agent computer system generates a subprofile scripts for each account related to the user, and generates a web page with a URL, said subprofile scripts presenting themselves as clickable links on the web page.

9. The method according to claim 8, wherein the URL of the generated web page is forwarded to the user.

10. The method according to claim 9, wherein the URL of the generated web page is forwarded to the user with the e-mail forwarded for acknowledgement.

11. The method according to claim 9, wherein the user acknowledges the purchase request by clicking the URL representing the subprofile of the desired account.

12. The method according to claim 9, wherein the user annuls the purchase order by not clicking any subprofile.

13. The method according to claim 9, wherein the user annuls the purchase request by clicking an annulment clickable link.

14. The method according to any of claims 8-13, wherein the web page generated is deleted after the user's acknowledgement or annulment of the purchase request.

15. The method according to any of claims 8-14, wherein the second computer generates the subprofiles.

16. The method according to claim 15, wherein the second computer forwards the subprofiles to the web/script server, and said web/script server generates the web page with URL forwarded to the user.

17. The method according to claim 16, wherein the web/script server further forwards the acknowledgement e-mail comprising the web page URL to the user.

18. The method according to any of the preceding claims, wherein the generated web page hosting the subprofiles generated is deleted after a predetermined time period.

19. The method according to any of claims 4-18, wherein the communication from the first computer to the second computer is encrypted.

20. The method according to any of claims 4-19, wherein the communication between the first computer and the second computer is a one-way communication from the first computer to the second computer.

21. The method according to any of claims 6-20, wherein the web/script server forwards acknowledgement/annulment information to the second computer.

22. The method according to any of claims 6-21, wherein the web/script server forwards acknowledgement/annulment information to the first computer, and said first computer forwards the acknowledgement/annulment information to the second computer.

23. The method according to any of the preceding claims, wherein the secure agent computer system, after receipt of acknowledgement from the user, forwards information to the user, said information at least including purchase data and/or information about the selected account.

24. The method according to any of the preceding claims, wherein the secure agent computer system directs payment from account supplier to seller's account.

25. The method according to any of the preceding claims, wherein the link directs the user to the first computer of the secure agent computer system.

26. The method according to claim 25, wherein the secure agent computer system, after having received the user's purchase data, generates a message to the user.

27. The method according to claim 25, wherein the user is redirected to the seller's website after having received the message.

28. The method according to any of the preceding claims, wherein the account information is bank account information or credit card information.

29. The method according to any of the preceding claims, wherein said secure agent computer system stores thereon a master profile for each user, said user master profile comprising at least user name, user address, and at least one subprofile comprising account information.

30. The method according to any of the preceding claims, wherein the payment is forwarded directly from the account supplier to a predetermined account of the seller.

31. The method according to any of the preceding claims, wherein the payment is forwarded directly from the secure agent computer system to a predetermined account of the seller.

32. A system for enabling a secure electronic purchase transaction on a public computer network, said network comprising
a secure agent computer system having stored thereon account information for a plurality of users,
a user computer,
a seller's website, said seller's website having a link to the secure agent computer system.

33. The system according to claim 32, wherein said link directs the user to the secure agent computer system.

34. The system according to claim 32 or 33, comprising any of the features defined in any of claims 1-31.
